(19) United States
(12) Patent Application Publication
(10) Pub. No.: US 2006/0101937 A1
(43) Pub. Date: May 18, 2006

(54) Cable connection and method of connecting a cable between two relative to each other moving parts of a robot

(75) Inventors: Dan Salomonsson, Vasteras (SE); Mikael Holmberg, Skutulna (SE)

Correspondence Address: VENABLE LLP, P.O. BOX 34385, WASHINGTON, DC, 20045-9998, US

(73) Assignee: ABB AB, Vasteras (SE)

(21) Appl. No.: 10/521,328

(22) PCT Filed: Jul. 11, 2003
(86) PCT No.: PCT/SE03/01200

§ 371 Date: Sep. 22, 2005

(30) Foreign Application Priority Data
Jul. 16, 2002 (SE) 0202250-7

(51) Int. Cl. B25J 19/00

(52) U.S. Cl. 74/490.02

(57) ABSTRACT

An industrial robot having a first part and a second part that are arranged to be movable with respect to each other where at least one cable extends from the first part to the second part via an internal cavity. An excess of cable extends freely through the internal cavity from the first part to the second part. At least one cable is connected to at least one of the parts via a releasable contact point that is located inside the internal cavity.

### TECHNICAL FIELD

The present invention relates to an industrial robot having a first part and a second part that are movable with respect to each other where at least one cable extends from the first part to the second part via an internal cavity. More particularly the present invention concerns the wiring of said at least one cable between said first and second parts of the robot.

### BACKGROUND OF THE INVENTION

Industrial robots have a plurality of movable parts that can pivot or rotate relative to each other. Cables, hoses and pressure tubes have to be connected between the robot's movable parts for example to provide power to the robot and robot tools, to transmit communication signals to and from sensors and control systems and to supply pressurized gas or coolant to certain parts of the robot.

As the distance between individual points of the robot changes during the operation of the robot, the cables interconnecting the moving parts are consequently moved, elongated, bent and twisted. These undesirable distortions successively lead to fatigue breakdown, ultimately resulting in rupture of the connections. Worn or damaged cables have to be replaced at a frequency that depends on the amount and degree of distortion that they are subjected to in a specific application of the robot. Cables are often guided internally through the robot so as to protect the cables from damage that can occur during the robot's operation. The enclosure of cables inside the robot can however make maintenance and repair work troublesome and time consuming.

U.S. Pat. No. 6,125,715 discloses a device for supporting and guiding a cable between a robot arm and an assembly that is rotatable relative to the robot arm. The cable is secured to the device by fixing it to a holding element having a Z-shaped profile, which in turn is screwed onto the outer end of the robot arm. Tensioning straps are used to clamp the cables in place on the holding element.

The cable is coiled in a screw-line shape on the holding element in a first space provided in the assembly and then extends in a second space in the assembly to a contact point on the assembly. The screw-line formation allows the assembly to rotate reciprocally without the excessive force influencing the cable. When the assembly rotates in one direction the cable increases its diameter and when the assembly rotates in the other direction, the cable reduces its diameter. These two spaces are separated from each other in a sealed manner by means of a cup-shaped separation element which comprises members for sealing against the inside of the first space adjoining to a wall delimiting the first space. The wall of the separation element contains passages through which the cable is guided. The second space comprises a portion in which the cable extends substantially perpendicularly relative to the axis of rotation between the assembly and the arm part. The second space is delimited from the assembly by means of the separation element and one or more cover members arranged on the assembly.

While this device provides cable protection and a good seal between the assembly and the robot arm, wiring the cable through the device is time-consuming as the cable has to be guided through the device and attached to the holding element, which then has to be mounted on the robot arm. The cable must then be fed through the second space and be connected to the assembly whereupon the separation element has to be affixed to the inner walls of the assembly. Disassembly is likewise complicate and time consuming. The use of such a device leads to longer maintenance/repair times thereby decreasing productivity and increasing production costs.

Furthermore a robot often has to work in and/or access small or confined spaces. Housing a coil of cable and a cable-guiding device inside the robot arm requires a relatively large amount of space, which is only available to a limited extent particularly in the vicinity of a highly mobile robot hand. Incorporating a cable-guiding device into the robot hand also increases the weight of the robot hand.

### SUMMARY OF THE INVENTION

It is an object of this invention to provide a simple and cost-effective cable connection between two parts of a robot, which move relative to each other during the operation of the robot. By cable it is meant any channel that transmits energy such as electricity or an electric or optic signal, or that conveys a substance, such as gas or coolant, between two points. The expression “cable” includes both a single such channel or a plurality of such channels. Another object of the invention is to provide a cable connection that is capable of accommodating cable length changes caused by the movement of one or both of the robots movable parts with a minimum space requirement. It is also an object of the invention to provide a cable connection that allows rapid and simple assembly and disassembly to facilitate the replacement/maintenance of at least part of the cable.

These and other objects of the invention are achieved by providing an industrial robot with the cable connection described in the characterizing portion of claim 1. The industrial robot has first and second parts that are arranged movable with respect to each other. An excess of at least one cable extends freely to the second part via an internal cavity.

According to a preferred embodiment of the invention said at least one cable is connected to at least one of the parts via a contact that is located inside the internal cavity. According to another preferred embodiment of the invention this contact is releasable contact that facilitates simple and rapid connection and detachment of said at least one cable. Once the connection is broken, the transmission of for example power/signals/coolant/gas along the cable ceases. Alternatively the cable is merely secured to at least one of the parts at a point located inside the internal cavity. The cable is connected/secured only at the connection/securing points at its entrance and exit points into and out of the internal cavity. It is not supported or secured in any way inside the internal cavity between the connection/securing points at its entrance and exit points and is therefore free to move within the internal cavity.

The present invention concerns any two parts of an industrial robot that arranged to move with respect to each other, which are interconnected by at least one cable. This includes a first part that rotates or pivots about a second part and any other movement that gives rise to tension or slack in the interconnecting cable. According to preferred embodiments of the invention a cable connection is made between a robot arm and an electric motor located in a tilt housing at the end of the robot arm, or between the fixed base and rotatable stand of a robot or between the lower and upper arms of a robot.

According to a preferred embodiment of the invention the excess of cable forms an arch, a spiral or an S-shape inside the internal cavity. In a further preferred embodiment of the invention the excess of cable extends along an inner wall of the internal cavity so as to minimize the space requirement for said excess of cable.

The present invention also concerns a method of connecting at least part of at least one cable between a first part and a second part of an industrial robot which are arranged to be movable with respect to each other where said at least one cable extends from a first contact/securing point on the first part to a second contact/securing point on the second part via an internal cavity. The method comprises the steps of connecting/securing said at least one cable to the first contact/securing point, moving the first and second contact/securing points into a position where they are furthest from each other, extending a length of cable freely through the internal cavity from the first contact/securing point to the second contact/securing point and connecting/securing said at least one cable to the second part. The length of cable between the two contact/securing points is at least sufficient to extend between the two contact/securing points at their maximum displacement from each other. The excess of cable allows the cable to extend to the maximum extension required without over-tensioning, over-twisting or over-bending the cable.

### BRIEF DESCRIPTION OF THE DRAWING

The invention will now be described by way of example and with reference to the accompanying drawing in which:

FIG. 1 exemplifies a conventional six-axis industrial robot,

FIG. 2 is an enlarged view of the outer end of the upper arm of a robot that supports the tilt housing,

FIG. 3 shows an S-shaped cable connection according to a preferred embodiment of the invention,

FIG. 4 depicts an arched cable connection according to another preferred embodiment of the invention, and

FIG. 5 illustrates a spiral cable connection according to yet another preferred embodiment of the invention.

### DESCRIPTION OF THE PREFERRED EMBODIMENTS

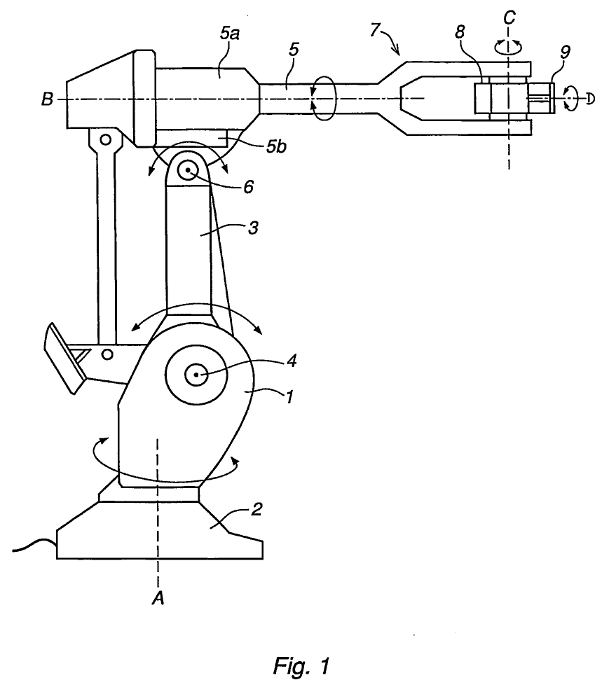

FIG. 1 shows a conventional six-axis industrial robot. The robot has a stand 1 that is rotatably mounted on a base 2, which enables it to rotate about vertical axis A. A lower robot arm 3 is pivotably mounted about axis 4. The lower robot arm 3 supports the robot's upper arm 5. The lower and upper arms are pivoted about axis 6. The upper arm 5 is rotatable about axis B that coincides with the longitudinal axis of the upper arm. The upper arm is journalled in a bearing housing 5a and a motor 5b, that is located adjacent to the bearing housing, actuates the rotation of the upper arm 5.

The upper arm supports a tilt housing 7 at its outer end. The tilt housing 7 is rotatable around axis C that is perpendicular to the longitudinal axis B of the upper arm 5. The tilt housing contains a drive unit comprising an electric motor 8. The output shaft of the electric motor drives a disc 9 that rotates about axis D that is at an angle in relation to the tilt housing. A robot tool or other desired attachment is mounted on the rotatable disc 9.

The industrial robot of the present invention is not restricted to six-axis industrial robots like the one schematically illustrated in FIG. 1 but is intended for use in any type of industrial robot used in any application such as welding, assembly work, spraying, painting, machine tending, lifting, picking, packing, cutting, grinding, polishing or for medical applications. The invention is particularly suitable for applications where a robot arm must be lightweight or able to operate in small or confined spaces.

As can be deduced from FIG. 1, there are several locations on a robot where the cable connection of the current invention can be utilized however the following figures will illustrate, by way of example only, an electric cable connection between a motor in a tilt housing and a robot arm.

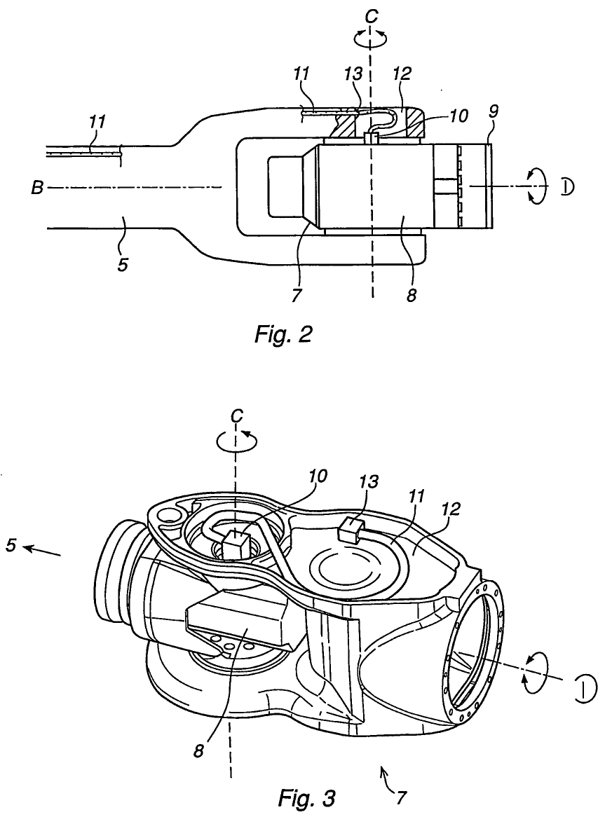

FIG. 2 shows a tilt housing 7 containing a motor 8 that drives a rotatable plate 9 onto which a tool can be mounted. The tilt housing 7 is suspended on axel pins rigidly connected to the two forks of the robot arm by means of two flanges arranged on opposite sides of the motor (not shown). A releasable contact attached to the sidewall of the motor protrudes into the internal cavity 12 between a flange and the side of the motor.

A cable 11 is wired along the robot arm 5 and is clamped at its entrance into the internal cavity 12 at point 13 by securing means such as a bundle strap. An excess of cable is then wired to extend freely inside the internal cavity 12 and is then connected to the motor 8 via contact 10. The excess of cable takes up tension/slack in the cable caused by the movement of the motor during the operation of the robot. The cable is entirely enclosed inside the robot and thus well protected and the motor unit is efficiently sealed to prevent contamination from its surroundings.

FIG. 3 shows a three-dimensional view of the tilt housing 7 containing a motor 8 having a releasable contact 10 to which a cable 11 is connected. An excess of cable extends freely inside an internal cavity 12 in the shape of an S. The cable is anchored to the robot arm at point 13. When the motor rotates about axis C in a clockwise direction the slack caused in the cable increases the diameter of the upper curve of the S furthest from the contact 10. When the motor rotates about axis C in an anti-clockwise direction the tension arising in the cable decreases the diameter in the upper curve of the S furthest from the contact 10. The cable 11 extends along the wall of the internal cavity. This means that the height of the cavity needs only to correspond to the diameter of the cable that it contains thus facilitating the use of the robot for accessing small or confined spaces.

Successive and reciprocal rotation of the motor progressively wears and damages the cable. When the cable needs to be replaced it can be disconnected from the contact 10 and released from the securing point 13 and a new section of cable can be connected. The replacement of the cable can therefore be accomplished very simply and rapidly. If the cable is connected at points 11 and 13 then this section of cable can be replaced without having to exchange the entire cable extending from the base of the robot to the elements supplied by the cable.

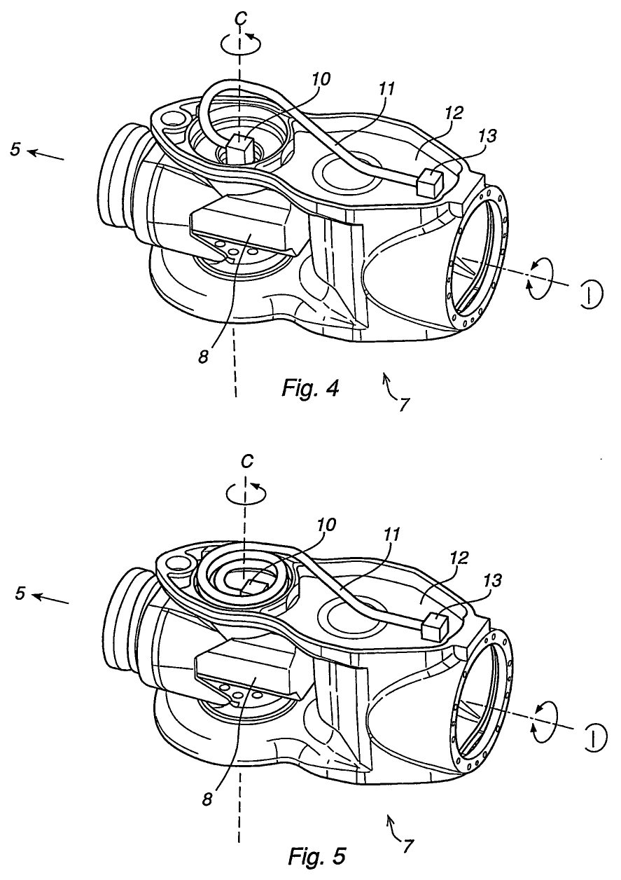

FIG. 4 shows a cable connection in which the cable 11 extending in the internal cavity 12 forms an arch between the contact 10 and the securing point 13. Rotation of the motor about vertical axis C results in the cable arch moving inside the cavity 12.

FIG. 5 illustrates a cable connection in which the cable 11 extending in the cavity 12 forms a spiral between the contact 10 and the securing point 13. When the motor rotates about axis C in a clockwise direction the slack arising in the cable increases the diameter of the spiral. When the motor rotates about axis C in an anti-clockwise direction the tension arising in the cable decreases the diameter of the spiral.

While only certain preferred features of the present invention have been illustrated and described, many modifications and changes will be apparent to those skilled in the art. It is therefore to be understood that all such modifications and changes of the present invention fall within the scope of the claims.

For example although the excess of cable has been exemplified as being in an arch, spiral or S-shape, a person skilled in the art will realize that the excess of cable constituting the cable connection of the present invention can take many geometrical forms to fulfill the aim of taking up the tension/slack in the cable caused by the movement of one or both of the movable parts that the cable interconnects.

1. An industrial robot having a first part and a second part that are arranged to be movable with respect to each other where at least one cable extends from the first part to the second part via an internal cavity, wherein an excess of cable extends freely through the internal cavity from the first part to the second part and wherein said at least one cable is connected to at least one of the parts via a releasable contact point that is located inside the internal cavity.

2. The robot according to claim 1, wherein one of said parts rotates or pivots about the other part.

3. The robot according to claim 1, wherein one of the parts comprises an electric motor.

4. The robot according to claim 1, wherein said excess of cable forms an arch inside the internal cavity.

5. The robot according to claim 1, wherein said excess of cable forms a spiral inside the internal cavity.

6. The robot according to claim 1, wherein said excess of cable forms an S-shape inside the internal cavity.

7. The robot according to claim 6, wherein the excess of cable extends along an inner wall of the internal cavity.

8. A method of connecting at least part of at least one cable between a first part and a second part of an industrial robot which are arranged to be movable with respect to each other where said at least one cable extends from a first contact/securing point on the first part to a second contact/securing point on the second part via an internal cavity, comprising connecting/securing said at least one cable to the first contact/securing point, moving the first and second contact/securing points into a position where they are furthest from each other, extending a length of cable freely through the internal cavity from the first contact/securing point to the second contact/securing point and connecting/securing said at least one cable releasably to the second part.
